(19) United States
(12) Patent Application Publication
(10) Pub. No.: US 2015/0263630 A1
(43) Pub. Date: Sep. 17, 2015

(54) POWER SUPPLY CIRCUIT

(71) Applicant: Kabushiki Kaisha Toshiba, Tokyo (JP)

(72) Inventors: Toshiyuki Naka, Nonoichi Ishikawa (JP); Yasunobu Saito, Nomi Ishikawa (JP); Hidetoshi Fujimoto, Kawasaki Kanagawa (JP); Akira Yoshioka, Nomi Ishikawa (JP); Tetsuya Ohno, Nomi Ishikawa (JP); Takeshi Uchihara, Kawaguchi Saitama (JP); Takaaki Yasumoto, Kawasaki Kanagawa (JP); Naoko Yanase, Inagi Tokyo (JP); Shingo Masuko, Kanazawa Ishikawa (JP); Tasuku Ono, Nonoichi Ishikawa (JP)

(21) Appl. No.: 14/482,231

(22) Filed: Sep. 10, 2014

(30) Foreign Application Priority Data
Mar. 14, 2014 (JP) 2014-052611

(51) Int. Cl. H02M 3/335

(52) U.S. Cl. CPC H02M 3/33546

(57) ABSTRACT

In one embodiment, a power supply circuit includes a first circuit including one or more first switching devices, and a first controller configured to control the first switching devices, the first circuit being configured to output a first voltage. The power supply circuit further includes a second circuit including one or more second switching devices which include a normally-on device, and a second controller configured to control the second switching devices, the second circuit being configured to output a second voltage generated from the first voltage. The second controller transmits a first signal for allowing the first circuit to output the first voltage, based on a value of a voltage or a current at a first node in the second circuit. The first controller allows the first circuit to output the first voltage by controlling the first switching devices in accordance with the first signal.

### CROSS REFERENCE TO RELATED APPLICATION

This application is based upon and claims the benefit of priority from the prior Japanese Patent Application No. 2014-52611, filed on Mar. 14, 2014, the entire contents of which are incorporated herein by reference.

### FIELD

Embodiments described herein relate to a power supply circuit.

### BACKGROUND

When a normally-on device is placed in an electric circuit such as a buck converter or a boost converter, there is a problem that as long as a controller for controlling operation of the normally-on device is not turned on, the controller cannot turn off the normally-on device. Therefore, a configuration has been considered in which a normally-off device is connected in series with the normally-on device to realize a normally-off function by these devices as a whole. This makes it possible to prevent a current from flowing through the normally-on device even before the controller is turned on. However, this normally-off device is not needed after the controller is turned on. Also, a power loss may be caused by the electric resistance of this normally-off device. Furthermore, when the normally-on device is placed in the electric circuit, an excessive current flowing through the normally-on device may destroy the normally-on device.

### BRIFE DESCRIPTION OF THE DRAWINGS

FIG. 1 is a circuit diagram showing a structure of a power supply circuit of a first embodiment;

FIG. 2 is a flowchart for explaining operation of the power supply circuit of the first embodiment in accordance with an EN signal;

FIG. 3 is a timing chart for explaining the operation of the power supply circuit of the first embodiment in accordance with the EN signal;

FIG. 4 is a flowchart for explaining operation of the power supply circuit of the first embodiment in accordance with a DEN signal;

FIG. 5 is a timing chart for explaining the operation of the power supply circuit of the first embodiment in accordance with the DEN signal; and

FIG. 6 is a circuit diagram showing a structure of a power supply circuit of a second embodiment.

### DETAILED DESCRIPTION

Embodiments will now be explained with reference to the accompanying drawings.

In one embodiment, a power supply circuit includes a first circuit including one or more first switching devices, and a first controller configured to control the first switching devices, the first circuit being configured to output a first voltage. The power supply circuit further includes a second circuit including one or more second switching devices which include a normally-on device, and a second controller configured to control the second switching devices, the second circuit being configured to output a second voltage generated from the first voltage. The second controller transmits a first signal for allowing the first circuit to output the first voltage, based on a value of a voltage or a current at a first node in the second circuit. The first controller allows the first circuit to output the first voltage by controlling the first switching devices in accordance with the first signal.

### First Embodiment

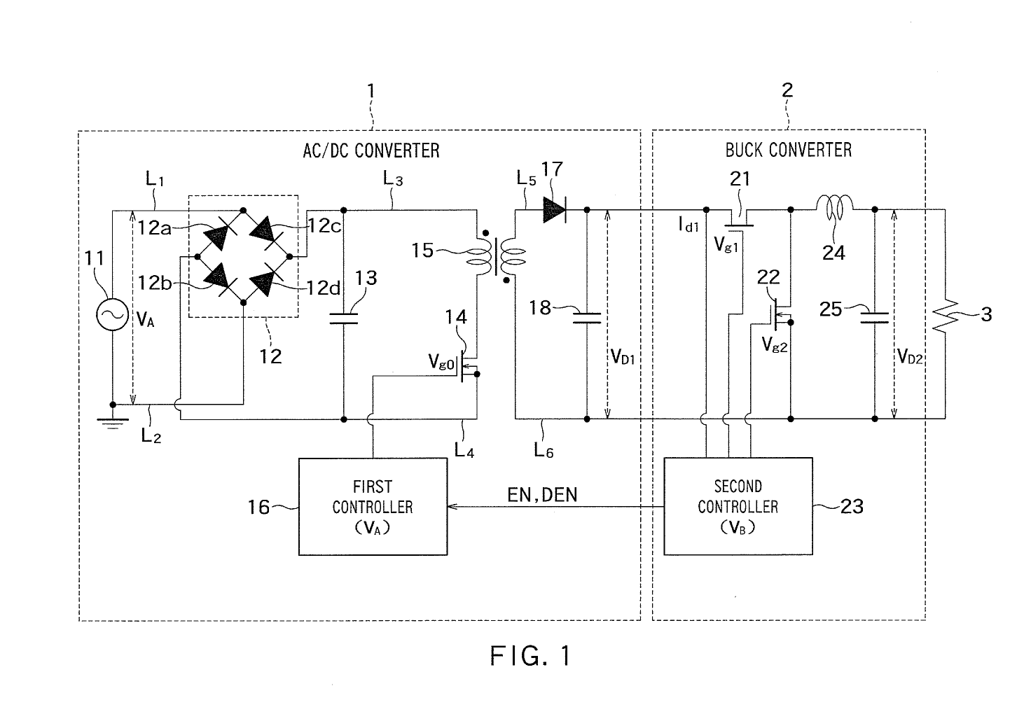

FIG. 1 is a circuit diagram showing a structure of a power supply circuit of a first embodiment.

The power supply circuit in FIG. 1 includes an AC/DC converter 1 as an example of a first circuit, and a buck converter 2 as an example of a second circuit.

The AC/DC converter 1 converts an AC voltage V_{A} into a first DC voltage V_{D1} and outputs the first DC voltage V_{D1}. The first DC voltage V_{D1} is an example of a first voltage. The buck converter 2 reduces the first DC voltage V_{D1} to a second DC voltage V_{D2} and output the second DC voltage V_{D2}. The second

DC voltage V_{D2} is an example of a second voltage generated from the first voltage. FIG. 1 shows the second DC voltage V_{D2} applied to a load 3.

The AC/DC converter 1 includes an AC power supply 11, a rectifier 12 including a first diode 12a, a second diode 12b, a third diode 12c and a fourth diode 12d, a first condenser 13, a switching device 14, a flyback converter 15, a first controller 16, a fifth diode 17 and a second condenser 18. The switching device 14 is an example of one or more first switching devices. The buck converter 2 includes a normally-on device 21, a normally-off device 22, a second controller 23, a choke coil 24 and a condenser 25. The normally-on device 21 and the normally-off device 22 are an example of one or more second switching devices.

The power supply circuit in FIG. 1 further includes power lines L₁, L₃ and L₅, and ground lines L₂, L₄ and L₆.

The AC power supply 11 generates the AC voltage V_{A}. The AV power supply 11 is connected to the power line L₁ and to the ground line L₂. The AC voltage V_{A} is supplied to the rectifier 12 via the lines L₁ and L₂.

The rectifier 12 is a full-wave rectifier including the first to fourth diodes 12ₐ to 12_{d}. A cathode of the first diode 12a and an anode of the third diode 12c are connected to the power line L₁. A cathode of the second diode 12b and an anode of the fourth diode 12d are connected to the ground line L₂. A cathode of the third diode 12c and a cathode of the fourth diode 12d are connected to the power line L₃. An anode of the first diode 12a and an anode of the second diode 12b are connected to the ground line L₄. The rectifier 12 executes full-wave rectification on the AC voltage V_{A} to convert the AC voltage V_{A} into a DC voltage.

The first condenser 13 is connected to the power line L₃ and to the ground line L₄. The first condenser 13 smoothes the DC voltage supplied by the rectifier 12. The DC voltage smoothed by the first condenser 13 is supplied to the switching device 14 and the flyback converter 15 via the lines L₃ and L₄.

The switching device 14 and the flyback converter 15 are connected in series with each other between the power line L₃ and the ground line L₄. The switching device 14 of the first embodiment is a normally-off MOSFET. Therefore, when a gate voltage V_{go} of the switching device 14 is 0 V, the switching device 14 is in an off state. A gate of the switching device 14 is connected to the first controller 16. A source of the switching device 14 is connected to the ground line L₄. A drain of the switching device 14 is connected to the power line L₃ via the flyback converter 15.

The flyback converter 15 is a kind of insulated converter. The flyback converter 15 includes a primary winding connected to the power line L₃ and to the ground line L₄, and a secondary winding connected to the power line L₅ and to the ground line L₆. When the switching device 14 is turned on, a DC current from the first condenser 13 flows through the primary winding. As a result, a core of the flyback converter 15 is magnetized and energy is stored in the core. Subsequently, when the switching device 14 is turned off, the energy stored in the core is released to allow a direct current to flow through the secondary winding.

The first controller 16 controls operation of the switching device 14. Specifically, the first controller 16 switches the switching device 14 from on to off to release the energy from the core of the flyback converter 15. This allows the AC/DC converter 1 to output the first DC voltage V_{D1}. Furthermore, the first controller 16 switches the switching device 14 from off to on to stop releasing the energy from the core. This allows the AC/DC converter 1 to stop outputting the first DC voltage V_{D1}.

The fifth diode 17 is placed on the power line L₅. The second condenser 18 is connected to the power line L₅ and to the ground line L₆. An anode of the fifth diode 17 is connected to the flyback converter 15. One of two electrodes of the second condenser 18 is connected to a cathode of the fifth diode 17. The other electrode of the second condenser 18 is connected to the flyback converter 15.

The fifth diode 17 has a function to inhibit an inductive current from flowing though the secondary winding in the flyback converter 15 when the switching device 14 is on. The second condenser 18 has a function to smooth a DC voltage fed through the secondary winding in the flyback converter 15 when the switching device 14 is off.

The normally-on device 21 is placed on the power line L₅. The normally-on device 21 of the first embodiment is a normally-on MOSFET. Therefore, when the gate voltage V_{g1} of the normally-on device 21 is 0 V, the normally-on device 21 is in an on state.

The normally-off device 22 is connected to the power line L₅ and to the ground line L₆. The normally-off device 22 of the first embodiment is a normally-off MOSFET. Therefore, when a gate voltage V_{g2} of the normally-off device 22 is 0 V, the normally-off device 22 is in an off state.

A gate of the normally-on device 21 and a gate of the normally-off device 22 are connected to the second controller 23. A drain of the normally-on device 21 is connected to the second condenser 18. A source of the normally-on device 21 is connected to a drain of the normally-off device 22. A source of the normally-off device 22 is connected to the second condenser 18 via the ground line L₆.

The second controller 23 controls operation of the normally-on device 21 and the normally-off device 22.

Specifically, the second controller 23 repeatedly switches on and off the normally-on device 21 and the normally-off device 22 to allow the buck converter 2 to output the second DC voltage V_{D2}. Furthermore, the second controller 23 turns off the normally-on device 21 and the normally-off device 22 to allow the buck converter 2 to stop outputting the second DC voltage V_{D2}.

The second controller 23 is connected to the power line L₅ near the drain of the normally-on device 21. Therefore, the second controller 23 can detect a drain current I_{d1} flowing through the normally-on device 21. The choke coil 24 is placed on the power line L₅. The condenser 25 is connected to the power line L₅ and to the ground line L₆. One of two terminals of the choke coil 24 is connected to the normally-on device 21 and to the normally-off device 22. The other terminal of the choke coil 24 is connected to the condenser 25. One of two electrodes of the condenser 25 is connected to the choke coil 24. The other electrode of the condenser 25 is connected to the normally-off device 22 via the ground line

When the normally-on device 21 is turned on and the normally-off device 22 is turned off, a current flows from an input of the buck converter 2 to an output of the buck converter 2. This allows energy to be stored in the choke coil 24. Subsequently, when the normally-on device 21 is turned off and the normally-off device 22 is turned on, the choke coil 24 generates an electromotive force, allowing a current to flow through the normally-off device 22. The buck converter 2 repeats the above-described process to enable a reduction from the first DC voltage V_{D1} to the second DC voltage V_{D2}. The condenser 25 has a function to smooth the second DC voltage V_{D2} before outputting of the second DC voltage V_{D2}.

### (1) EN Signal of First Embodiment

With reference to FIG. 1 continuously, an enable (EN) signal of the first embodiment will be described. The EN signal is an example of a first signal.

The EN signal is used to allow the AC/DC converter 1 to output the first DC voltage V_{D1}. When the power supply circuit is turned on and the second controller 23 changes from a non-standby state to a standby state, the second controller 23 transmits the EN signal to the first controller 16. Specifically, the second controller 23 switches the EN signal from low to high.

When the first controller 16 receives the EN signal from the second controller 23 (i.e., when the EN signal is switched from low to high), the first controller 16 switches the switching device 14 from on to off. This allows the AC/DC converter 1 to output the first DC voltage V_{D1} to the buck converter 2. Subsequently, the buck converter 2 reduces the first DC voltage V_{D1} to the second DC voltage V_{D2} and outputs the second DC voltage V_{D2}.

The second controller 23 determines whether the second controller 23 is in the non-standby state or in the standby state, based on a value of a voltage or a current at a predetermined node in the buck converter 2. Specifically, the second controller 23 determines that the second controller 23 is in the standby state when the value of the voltage V_{B} of the predetermined node in the second controller 23 is greater than a first set value V_{B}th. The predetermined node is an example of a first node. When the voltage V_{B} is higher than the first set value V_{B}th, the second controller 23 transmits the EN signal to the first controller 16.

As described above, when the second controller 23 is changed into the standby state, the second controller 23 transmits the EN signal, and the first controller 16 allows the AC/DC converter 1 to output the first DC voltage V_{D1} in accordance with the EN signal. Therefore, the first embodiment makes it possible to prevent a current from flowing through the normally-on device 21 before the second controller 23 is turned on (standby state). Furthermore, the first embodiment can eliminate the need to arrange a dedicated normally-off device for preventing a current flow through the normally-on device 21. This allows avoidance of a power loss caused by the electric resistance of such a normally-off device.

Regarding the EN signal of the first embodiment, low logic may be adopted instead of high logic. In other words, the power supply circuit of the first embodiment may adopt a configuration in which the EN signal is switched from high to low to allow the AC/DC converter 1 to output the first DC voltage V_{D1}.

Furthermore, the second controller 23 may determine whether or not the second controller 23 is in the standby state, based on the value of the voltage instead of the value of the current.

### (2) DEN Signal of First Embodiment

With reference to FIG. 1 continuously, a disenable (DEN) signal of the first embodiment will be described. The DEN signal is an example of a second signal.

The DEN signal is used to allow the AC/DC converter 1 to stop outputting the first DC voltage V_{D1}. If there is a possibility that the normally-on device 21 is destroyed when the power supply circuit is on, the second controller 23 transmits the DEN signal to the first controller 16. Specifically, the second controller 23 switches the DEN signal from low to high.

When the first controller 16 receives the DEN signal from the second controller 23 (i.e., when the DEN signal is switched from low to high), the first controller 16 switches the switching device 14 from off to on. This allows the AC/DC converter 1 to stop outputting the first DC voltage V_{D1} to the buck converter 2, and also allows the buck converter 2 to stop outputting the second DC voltage V_{D2}.

The second controller 23 determines whether there is a possibility that the normally-on device 21 is destroyed, based on the value of the voltage or current at a predetermined node in the buck converter 2. Specifically, the second controller 23 determines that there is a possibility that the normally-on device 21 is destroyed, when the value of the drain current I_{d1} flowing through a node near the drain of the normally-on device 21 rises to a second set value I_{d1}th. The predetermined node is an example of a second node. When the drain current I_{d1} rises to the second set value I_{d1}th, the second controller 23 transmits the DEN signal to the first controller 16.

As described above, when there is a possibility that the normally-on device 21 is destroyed, the second controller 23 transmits the DEN signal, and the first controller 16 allows the AC/DC converter 1 to stop outputting the first DC voltage V_{D1} in accordance with the DEN signal. Therefore, the first embodiment makes it possible to prevent the normally-on device 21 from being destroyed due to an excessive current or the like.

Regarding the DEN signal of the first embodiment, the low logic may be adopted instead of the high logic. In other words, the power supply circuit of the first embodiment may adopt a configuration in which the DEN signal is switched from high to low to allow the AC/DC converter 1 to stop outputting the first DC voltage V_{D1}.

Furthermore, the second controller 23 of the first embodiment may determine whether there is a possibility that the normally-on device 21 is destroyed, based on the value of the voltage instead of the value of the current.

### (3) Operation of Power Supply Circuit of First Embodiment

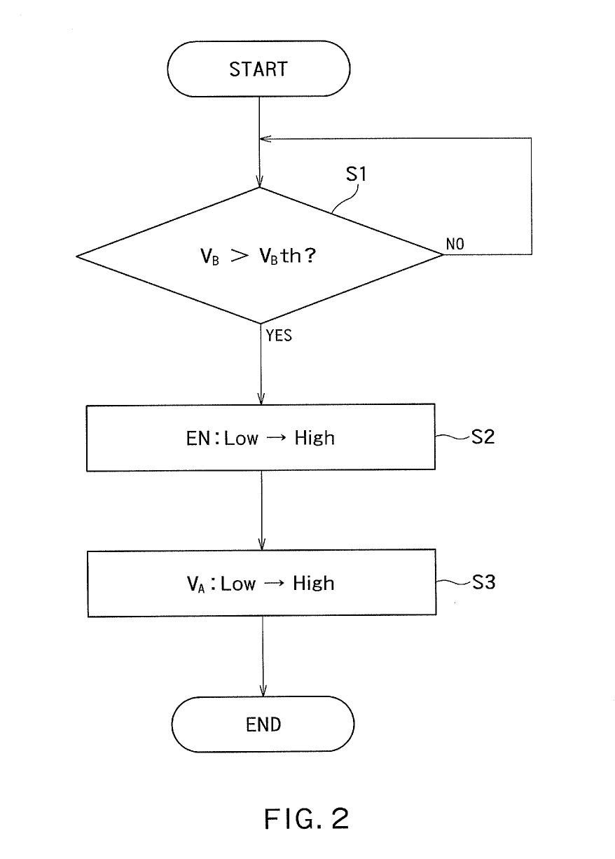

Operation of the power supply circuit of the first embodiment will be described with reference to FIGS. 2 to 5.

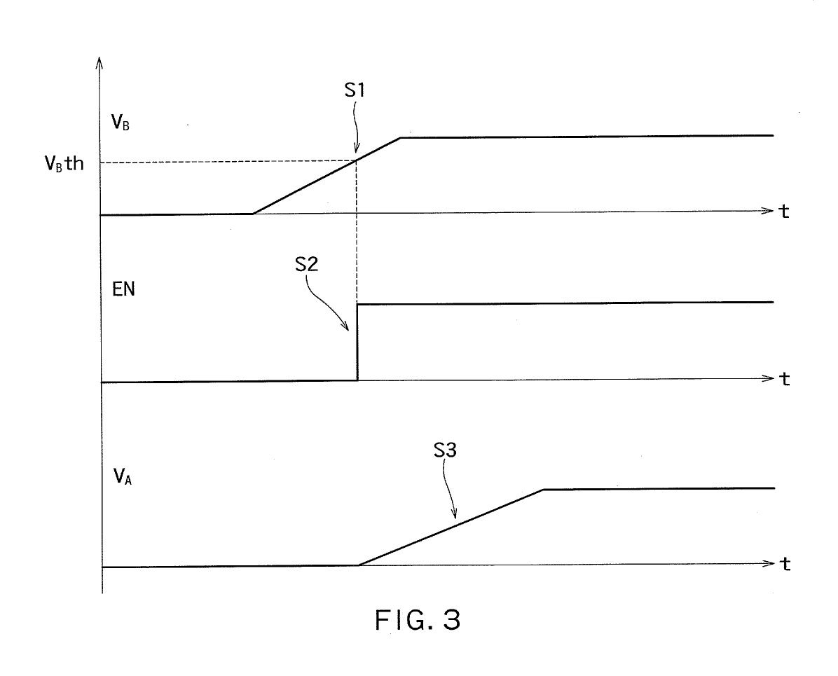

FIGS. 2 and 3 are a flowchart and a timing chart for explaining the operation of the power supply circuit of the first embodiment in accordance with the EN signal, respectively.

When the power supply circuit is turned on, the voltage V_{B} of the predetermined node in the second controller 23 starts to rise. Then, when the voltage V_{B} becomes higher than the first set value V_{B}th (step S1), the second controller 23 transmits the EN signal (step S2).

When the first controller 16 receives the EN signal, the voltage V_{A} of the predetermined node in the first controller 16 starts to rise (step S3). When the voltage V_{A} is switched from low to high, the first controller 16 turns the switching device 14 on and subsequently switches the switching device 14 to off. Consequently, the AC/DC converter 1 outputs the first DC voltage V_{D1} to the buck converter 2.

The predetermined node in the first controller 16 of the first embodiment is a node related to the application of the gate voltage V_{g0} to the switching device 14. When the voltage V_{A} of the predetermined node becomes higher than a set value, the first controller 16 can apply the needed gate voltage V_{g0} to the switching device 14.

The predetermined node in the second controller 23 of the first embodiment is a node related to the application of the gate voltage V_{g1} to the normally-on device 21. When the voltage V_{B} of the predetermined node becomes higher than a set value (first set value V_{B}th), the second controller 23 can apply the needed gate voltage V_{g1} to the normally-on device 21.

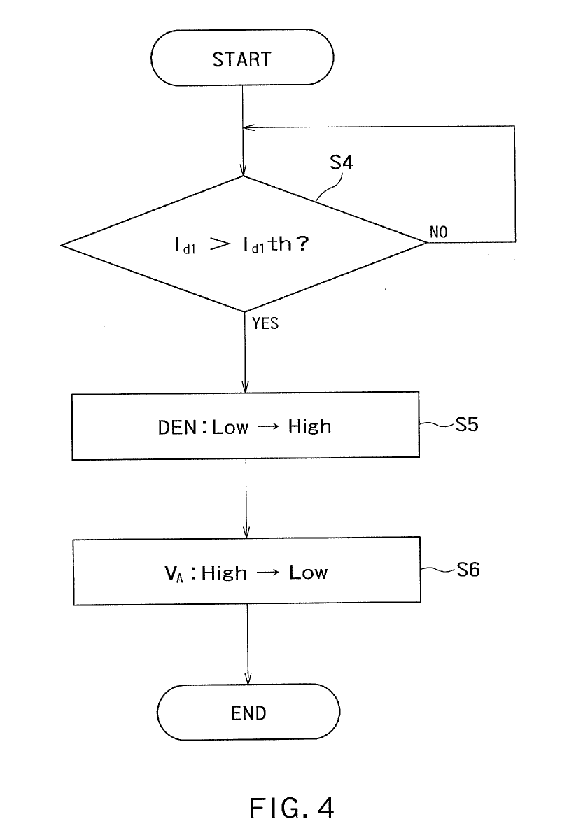

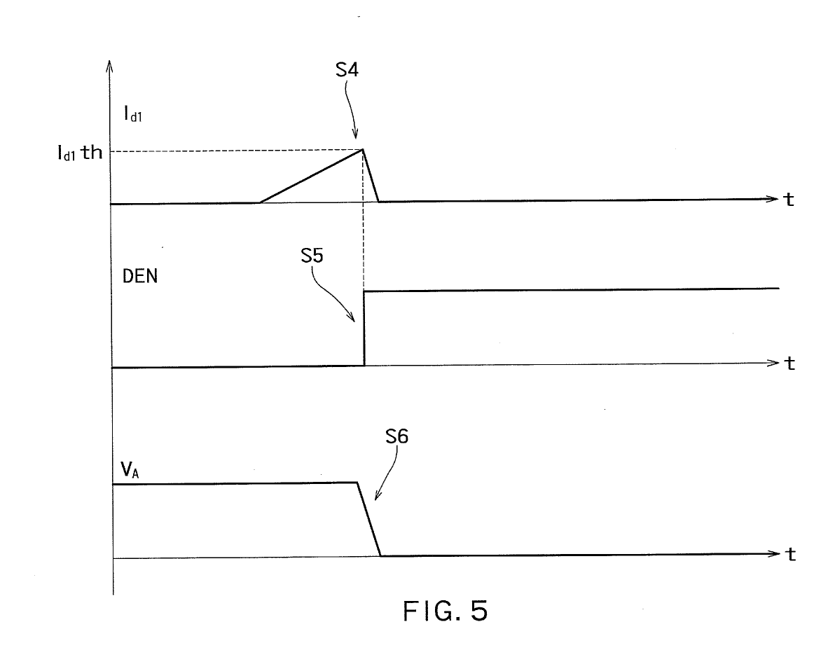

FIGS. 4 and 5 are a flowchart and a timing chart for explaining the operation of the power supply circuit of the first embodiment in accordance with the DEN signal, respectively.

When the drain current I_{d1} in the normally-on device 21 rises to the second set value I_{d1}th (step S4) while the power supply circuit is on, the second controller 23 transmits the DEN signal (step S5).

When the first controller 16 receives the DEN signal, the first controller 16 lowers the voltage V_{A} of the predetermined node in the first controller 16 (step S6), and switches the switching device 14 from off to on. This allows the AC/DC converter 1 to stop outputting the first DC voltage V_{D1}, returning the voltage V_{A} from high to low.

As described above, the second controller 23 transmits the EN signal based on the value of the voltage or current at the predetermined node in the buck converter 2, and the first controller 16 allows the AC/DC converter 1 to output the first DC voltage V_{D1} in accordance with the EN signal. Therefore, the first embodiment makes it possible to prevent a current from flowing through the normally-on device 21 before the second controller 23 is turned on.

Furthermore, the second controller 23 transmits the DEN signal based on the value of the voltage or current at the predetermined node in the buck converter 2, and the first controller 16 allows the AC/DC converter 1 to stop outputting the first DC voltage V_{D1} in accordance with the DEN signal. Therefore, the first embodiment makes it possible to prevent the normally-on device 21 from being destroyed due to an excessive current or the like.

In this manner, the first embodiment can provide a power supply circuit including the first controller 16 and the second controller 23 which allow the normally-on device 21 to operate appropriately.

In the first embodiment, the arrangement of the normally-on device 21 may be replaced with the arrangement of the normally-off device 22. In other words, the normally-off device 22 may be arranged on the power line L₅, and the normally-on device 21 may be connected to the power line L₅ and to the ground line L₅ in the first embodiment.

In the first embodiment, both the normally-on device 21 and the normally-off device 22 may be replaced with normally-on devices. In this case, the second controller 23 desirably transmits the DEN signal when the drain current through at least one of the normally-on devices rises to the second set value I_{d1}th. Additionally, the control performed by the second controller 23 of the first embodiment is applicable to any of the normally-on devices in the buck converter 2.

Moreover, the second circuit of the first embodiment may be any circuit other than the buck converter 2. An example of such a second circuit is a boost converter 4 of a second embodiment described below.

### Second Embodiment

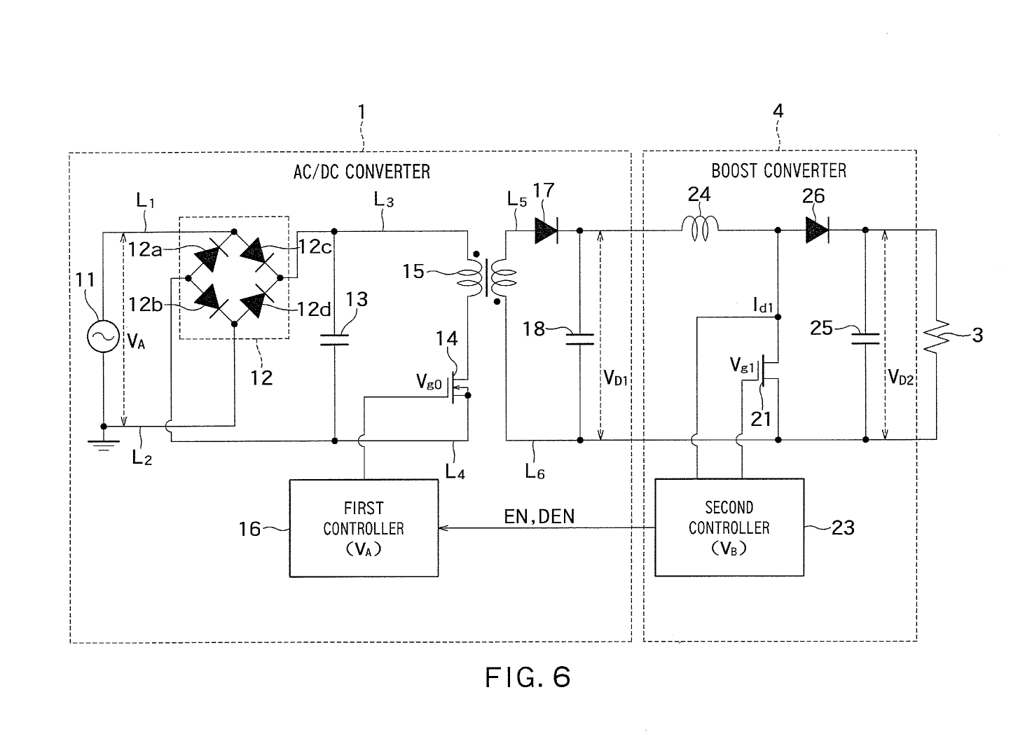

FIG. 6 is a circuit diagram showing a structure of a power supply circuit of a second embodiment.

The power supply circuit in FIG. 6 includes an AC/DC converter 1 as an example of the first circuit, and a boost converter 4 as an example of the second circuit. The structure of the AC/DC converter 1 in FIG. 6 is similar to the structure of the AC/DC converter 1 in FIG. 1.

The AC/DC converter 1 coverts the AC voltage V_{A} into the first DC voltage V_{D1} and outputs the first DC voltage V_{D1}. The boost converter 4 increases the first DC voltage V_{D1} to the second DC voltage V_{D2} and outputs the second DC voltage V_{D2}. FIG. 6 shows the second DC voltage V_{D2} applied to a load 3.

The boost converter 4 includes a normally-on device 21, a second controller 23, a choke coil 24, a condenser 25 and a diode 26.

The normally-on device 21 is connected to the power line L₅ and to the ground line L₆. A gate of the normally-on device 21 is connected to the second controller 23. A drain of the normally-on device 21 is connected to a power line L₅. A source of the normally-on device 21 is connected to a ground line L₆.

The second controller 23 controls operation of the normally-on device 21. Specifically, the second controller 23 repeatedly switches on and off the normally-on device 21 to allow the boost converter 4 to output the second DC voltage V_{D2}.

The second controller 23 is connected to a line near a drain of the normally-on device 21. Therefore, the second controller 23 can detect a drain current I_{d1} flowing through the normally-on device 21.

The choke coil 24 is placed on the power line L₅. One of two terminals of the choke coil 24 is connected to a second condenser 18. The other terminal of the choke coil 24 is connected to a drain of the normally-on device 21.

The diode 26 is placed on the power line L₅. The condenser 25 is connected to the power line L₅ and to the ground line L₆. An anode of the diode 26 is connected to the normally-on device 21 and to the choke coil 24. One of two electrodes of the condenser 25 is connected to a cathode of the diode 26. The other electrode of the condenser 25 is connected to the normally-on device 21 via the ground line L₆.

When the normally-on device 21 is turned on, a current flows through the normally-on device 21, and energy is stored in the choke coil 24. Subsequently, when the normally-on device 21 is turned off, the choke coil 24 generates an electromotive force, and a current flows from an input of the boost converter 4 to an output of the boost converter 4. The boost converter 4 repeats the above-described process to enable an increase from the first DC voltage V_{D1} to the second DC voltage V_{D2}.

The first controller 16 and second controller 23 of the second embodiment can operate similarly to the first controller 16 and second controller 23 of the first embodiment.

The second controller 23 transmits the EN signal, based on a value of a voltage or a current at a predetermined node in the boost converter 4. The first controller 16 allows the AC/DC converter 1 to output the first DC voltage V_{D1} in accordance with the EN signal. Therefore, the second embodiment makes it possible to prevent a current from flowing through the normally-on device 21 before the second controller 23 is turned on.

Furthermore, the second controller 23 transmits the DEN signal, based on a value of a voltage or current at a predetermined node in the boost converter 4. The first controller 16 allows the AC/DC converter 1 to stop outputting the first DC voltage V_{D1} in accordance with the DEN signal. Therefore, the second embodiment makes it possible to prevent the normally-on device 21 from being destroyed due to an excessive current or the like.

In this manner, the second embodiment can provide a power supply circuit including the first controller 16 and second controller 23 which allow the normally-on device 21 to operate appropriately, similarly to the first embodiment.

While certain embodiments have been described, these embodiments have been presented by way of example only, and are not intended to limit the scope of the inventions. Indeed, the novel circuits described herein may be embodied in a variety of other forms; furthermore, various omissions, substitutions and changes in the form of the circuits described herein may be made without departing from the spirit of the inventions. The accompanying claims and their equivalents are intended to cover such forms or modifications as would fall within the scope and spirit of the inventions.

1. A power supply circuit comprising:
a first circuit including one or more first switching devices, and a first controller configured to control the first switching devices, the first circuit being configured to output a first voltage; and
a second circuit including one or more second switching devices which include a normally-on device, and a second controller configured to control the second switching devices, the second circuit being configured to output a second voltage generated from the first voltage,
wherein
the second controller transmits a first signal for allowing the first circuit to output the first voltage, based on a value of a voltage or a current at a first node in the second circuit, and
the first controller allows the first circuit to output the first voltage by controlling the first switching devices in accordance with the first signal.

2. The power supply circuit of claim 1, wherein the second controller transmits the first signal when the value of the voltage at the first node is greater than a first set value.

3. The power supply circuit of claim 1, wherein the second controller transmits the first signal when a state of the second controller changes from a non-standby state to a standby state.

4. The power supply circuit of claim 1, wherein the first circuit converts an AC voltage into a first DC voltage, and outputs the first DC voltage as the first voltage.

5. The power supply circuit of claim 4, wherein the second circuit reduces or increases the first DC voltage to a second DC voltage, and outputs the second DC voltage as the second voltage.

6. The power supply circuit of claim 1, wherein the first circuit includes an insulated converter connected in series with one of the first switching devices.

7. The power supply circuit of claim 1, wherein the second circuit includes:
a first transistor provided on a power line;
a second transistor provided between the power line and a ground line;
an inductor provided on the power line; and
a capacitor provided between the power line and the ground line.

8. The power supply circuit of claim 7, wherein the first transistor is the normally-on device, and the second transistor is a normally-off device.

9. The power supply circuit of claim 1, wherein the second circuit includes:
a transistor provided between a power line and a ground line;
an inductor provided on the power line;
a capacitor provided between the power line and the ground line; and
a rectifier provided on the power line.

10. The power supply circuit of claim 9, wherein the transistor is the normally-on device.

11. A power supply circuit comprising:
a first circuit including one or more first switching devices, and a first controller configured to control the first switching devices, the first circuit being configured to output a first voltage; and
a second circuit including one or more second switching devices which include a normally-on device, and a second controller configured to control the second switching devices, the second circuit being configured to output a second voltage generated from the first voltage,
wherein
the second controller transmits a second signal for allowing the first circuit to stop outputting the first voltage, based on a value of a voltage or a current at a second node in the second circuit, and
the first controller allows the first circuit to stop outputting the first voltage by controlling the first switching devices in accordance with the second signal.

12. The power supply circuit of claim 11, wherein the second controller transmits the second signal when the value of the current at the second node increases to a second set value.

13. The power supply circuit of claim 11, wherein the second controller transmits the second signal, based on the value of the current flowing through the normally-on device.

14. The power supply circuit of claim 11, wherein the first circuit converts an AC voltage into a first DC voltage, and outputs the first DC voltage as the first voltage.

15. The power supply circuit of claim 14, wherein the second circuit reduces or increases the first DC voltage to a second DC voltage, and outputs the second DC voltage as the second voltage.

16. The power supply circuit of claim 11, wherein the first circuit includes an insulated converter connected in series with one of the first switching devices.

17. The power supply circuit of claim 11, wherein the second circuit includes:
a first transistor provided on a power line;
a second transistor provided between the power line and a ground line;
an inductor provided on the power line; and
a capacitor provided between the power line and the ground line.

18. The power supply circuit of claim 17, wherein the first transistor is the normally-on device, and the second transistor is a normally-off device.

19. The power supply circuit of claim 11, wherein the second circuit includes:
a transistor provided between a power line and a ground line;
an inductor provided on the power line;
a capacitor provided between the power line and the ground line; and
a rectifier provided on the power line.

20. The power supply circuit of claim 19, wherein the transistor is the normally-on device.
